(19) United States
(12) Patent Application Publication
(10) Pub. No.: US 2019/0154009 A1
(43) Pub. Date: May 23, 2019

(54) RECIRCULATING GRADIENT POWER SYSTEM

(71) Applicant: IMUSHROOM DIGITAL LIMITED, Taoyuan (TW)

(72) Inventors: CHI-CHUNG LO, Taoyuan (TW); MING-HSIU LEE, Taoyuan (TW)

(21) Appl. No.: 16/251,879

(22) Filed: Jan. 18, 2019

Related U.S. Application Data
(63) Continuation-in-part of application No. 15/499,992, filed on Apr. 28, 2017.

(30) Foreign Application Priority Data
May 13, 2016 (CN) 201610317269.1

(51) Int. Cl. F03G 3/00; F03G 7/08; F15B 15/06; F15B 15/14

(52) U.S. Cl. CPC F03G 3/00; F03G 7/08; F05B 2260/403; F15B 15/1409; F15B 15/06

(57) ABSTRACT

A recirculating gradient power system includes a motion carrier, a counterweight, power cylinders and a control module. A central vertical axis of the motion carrier has a rotating shaft pivotally connected with the counterweight. The power cylinders connected with a pressure source are evenly arranged at diagonal corners around the periphery of the central vertical axis. The control module connected with the power cylinders controls operation of the power cylinders which are set in advance when the counterweight is rotationally displaced to a predetermined stroke. The pressure source sequentially provides compressed gas fluid to the power cylinders to make the motion carrier continuously change its tilt orientation and tilt angle, thus forming a virtual continuous gradient. The counterweight is rotationally displaced from a high point of the motion carrier toward a lower point of the motion carrier about the rotating shaft by gravity, and the rotating shaft rotates continuously.

### CROSS-REFERENCE TO RELATED APPLICATION

This application is a continuation-in-part of U.S. patent application Ser. No. 15/499,992, filed at Apr. 28, 2017, claiming priority to China patent application No. 201610317269.1 filed at May 13, 2016.

### FIELD OF THE INVENTION

The present invention relates to a power output system, and more particularly to a recirculating gradient power system, wherein a motion carrier changes its tilt orientation and tilt angle to make a counterweight is rotationally displaced from a high point of the motion carrier toward a lower point of the motion carrier about a rotating shaft, thus forming the rotating motion of the rotating shaft.

### BACKGROUND OF THE INVENTION

GB Patent GB2527102A provides a gravity oscillating system for generating electrical power. GB2527102A discloses that a plurality of electromagnets are momentarily energized to move the track down ahead of the rolling mass (a heavy ball), when the electromagnets is energized, the electronmagnets may attract a corresponding counter-part magnet or magnetisable element on the track to pull that part of the track downwards. The power transfer mechanism is linked to the track and an electrical generator, so that track oscillations can be used to generate electrical power. However, the heavy ball may be easily intercepted by an unexpected external force during the rolling process, causing the operation of the gravity oscillating system to be interrupted.

US Patent Publication US2006/0225414A1 discloses a pneumatic generator cycle system comprises a tablet, a plurality of cylinders, a carrier, and a pneumatic generator. The carrier is positioned on the tablet which is connected with a pillar. The carrier is allowed to move around the pillar and keeping a certain distance from the pillar. Though the carrier in US2006/0225414A1 may be prevented from being pulled out from the tablet due to the centrifugal force, it generates abrasion of the carrier since the carrier directly contacts the tablet and moves on the tablet. Thus, the whole tablet should be replaced when the abrasion of the tablet reaches a certain level. Additionally, in U.S. Pat. No. 4,915,196, a power driven weighted structure has driving wheels under the power driven weighted structure for decrease abrasion of the top surface of the load member. However, when the abrasion of the top surface reaches a certain level, the whole load member still should be replaced. Moreover, in U.S. Pat. No. 5,048,356, a movable carriage contacts a platform via rollers. Thus, when the abrasion of the platform reaches a certain level, the whole platform still should be replaced.

In addition to the problem of replacing the whole platform (or other similar components) as mentioned above, since the mass center of the carrier is located on the platform, when the platform is tilted by the gravity applying on the carrier, the highest position which the carrier (or other similar components) as mentioned above is positioned is not the ideal position which the carrier obtains the optimum gravity energy. This also causes the converted kinetic energy is not ideal, after the subsequent carrier rotates from the high point to the low point to convert the gravity potential energy into kinetic energy.

### SUMMARY OF THE INVENTION

The primary object of the present invention is to provide a recirculating gradient power system which is designed to include a motion carrier, a rotating shaft, a counterweight, a plurality of power cylinders, and a control module, and under the incorporation of the control module and the all power cylinders, the recirculating gradient power system can cause the rotational motion of the rotating shaft. The recirculating gradient power system can be utilized in different applications, for example, the teaching tool, the playing facility of the playground, the electrical power generating means, or the combination of the above.

In order to achieve the aforesaid object, the recirculating gradient power system of the present invention comprises a motion carrier, a rotating shaft, a counterweight, a plurality of power cylinders, and a control module. The motion carrier is horizontally arranged and has a central vertical axis as a pivot to change its tilt orientation and tilt angle. The motion carrier is provided with a track being annularly disposed on the motion carrier. The rotating shaft is vertically disposed at the position of the central vertical axis of the motion carrier. The counterweight is pivotally connected to the rotating shaft through a coupling mechanism. The counterweight is rotationally displaced from a high point of the motion carrier toward a lower point of the motion carrier about the rotating shaft by gravity to rotate the rotating shaft synchronously. The counterweight is provided with at least one roller in contact with the track to roll on the track, two ends of the coupling mechanism are pivotally connected to the rotating shaft and the counterweight, respectively, and the counterweight is disposed at a position where the center of mass of the counterweight is located at an outer side of the motion carrier. The power cylinders are evenly arranged at diagonal corners around the periphery of the central vertical axis of the motion carrier. Each of the power cylinders is provided with a push rod connected with a pressure source to drive the motion carrier to change the tilt orientation and the tilt angle. The pressure source is a fluid accumulator unit. The control module is provided with a plurality of valve elements connected with the power cylinders, and two ends of each the valve elements are respectively connected with the pressure source and the corresponding power cylinder via pipes, respectively. When the counterweight is rotationally displaced to a predetermined stroke, the control module controls the valve elements to be turned on/off to selectively make the power cylinders be communicated with the pressure source, so as to control the operation of the power cylinders which are set in advance.

According to the aforesaid technical feature, the counterweight is disposed at a position where the center of mass of the counterweight is located at an outer side of the track.

According to the aforesaid technical feature, a cross section of the track is a T-shaped structure, wherein the roller contacts a top portion of the T-shaped structure, and a bottom portion of the T-shaped structure is connected with the motion carrier.

According to the aforesaid technical feature, a surface of the track which contacts the roller is provided with a wear-resistant structure, and the wear-resistant structure is formed of a wear-resistant material, or formed by polishing the surface of the track.

According to the aforesaid technical feature, the counterweight is provided with at least two auxiliary rollers respectively corresponding to two sides of the track

According to the aforesaid technical feature, the coupling mechanism is provided with a pivot member fixed to the counterweight. One end of the pivot member is formed with two arms corresponding to two sides of the rotating shaft. A pin is provided to penetrate the two arms and the rotating shaft.

According to the aforesaid technical feature, the coupling mechanism is provided with a first connecting member fixed to the counterweight. A second connecting member is mounted on the first connecting member and is telescopic relative to the first connecting member. One end of the second connecting member is provided with a pivot member. One end of the pivot member is formed with two arms corresponding to two sides of the rotating shaft. A pin is provided to penetrate the two arms and the rotating shaft.

According to the aforesaid technical feature, the roller has an arc surface. The first connecting member is provided with two first stoppers thereon. At least one guide post is provided between the two first stoppers. The second connecting member is provided with a first sliding seat inserted between the two first stoppers. The first sliding seat is provided with at least one guide hole for the guide post of the first connecting member to insert therethrough.

According to the aforesaid technical feature, the roller has an arc surface. The first connecting member is provided with a slide rail thereon. A tail end of the first connecting member is provided with a second stopper. The second connecting member is provided with a second sliding seat. The second sliding seat is provided with at least one chute corresponding to the slide rail of the first connecting member.

According to the aforesaid technical feature, the recirculating gradient power system further comprises a base. The power cylinders are fixed to the base. The rotating shaft is pivotally disposed on the base. The motion carrier is mounted on the base through a universal coupling seat.

According to the aforesaid technical feature, the recirculating gradient power system further comprises at least one generator to constitute a transmission coupling in cooperation with the rotating shaft.

According to the aforesaid technical feature, the control module is provided with a plurality of contact sensing elements corresponding to the rotating shaft, respectively, or a plurality of non-contact sensing elements corresponding to the rotating shaft, respectively.

More specifically, the circulating gradient power system of the prevent invention has a track annularly disposed on the motion carrier, the surface of the track has the wear-resistant structure, and thus when the track has been worn or damaged, merely the track should be replaced without replacing the whole motion carrier. Further, the counterweight is disposed at a position where the center of mass of the counterweight is located at an outer side of the motion carrier, the counterweight can have the larger gravity potential energy, and thus, the converted kinetic energy becomes larger.

### BRIEF DESCRIPTION OF THE DRAWINGS

FIG. 1 is a perspective view of the circulating gradient power system in accordance with a first embodiment of the present invention;

FIG. 2 is a front view of the circulating gradient power system in accordance with the first embodiment of the present invention;

FIG. 3 is a schematic view of the circulating gradient power system in accordance with the first embodiment of the present invention, showing the operating state of the left power cylinder;

FIG. 4 is a schematic view of the circulating gradient power system in accordance with the first embodiment of the present invention, showing the operating state of the front power cylinder;

FIG. 5 is a schematic view of the circulating gradient power system in accordance with the first embodiment of the present invention, showing the operating state of the right power cylinder;

FIG. 6 is a schematic view of the circulating gradient power system in accordance with the first embodiment of the present invention, showing the operating state of the rear power cylinder;

FIG. 7 is a perspective view of the circulating gradient power system in accordance with a second embodiment of the present invention;

FIG. 8 is a front view of the circulating gradient power system in accordance with the second embodiment of the present invention;

FIG. 9 is a perspective view of the circulating gradient power system in accordance with a third embodiment of the present invention;

FIG. 10 is a front view of the circulating gradient power system in accordance with the third embodiment of the present invention;

FIG. 11 is a schematic view showing the operation of the circulating gradient power system in accordance with the third embodiment of the present invention;

FIG. 12 is a perspective view of the circulating gradient power system in accordance with a fourth embodiment of the present invention;

FIG. 13 is a front view of the circulating gradient power system in accordance with the fourth embodiment of the present invention;

FIG. 14 is a perspective view of the circulating gradient power system in accordance with a fifth embodiment of the present invention; and

FIG. 15 is a front view of the circulating gradient power system in accordance with the fifth embodiment of the present invention.

### DESCRIPTION OF THE PREFERRED EMBODIMENTS

Embodiments of the present invention will now be described, by way of example only, with reference to the accompanying drawings.

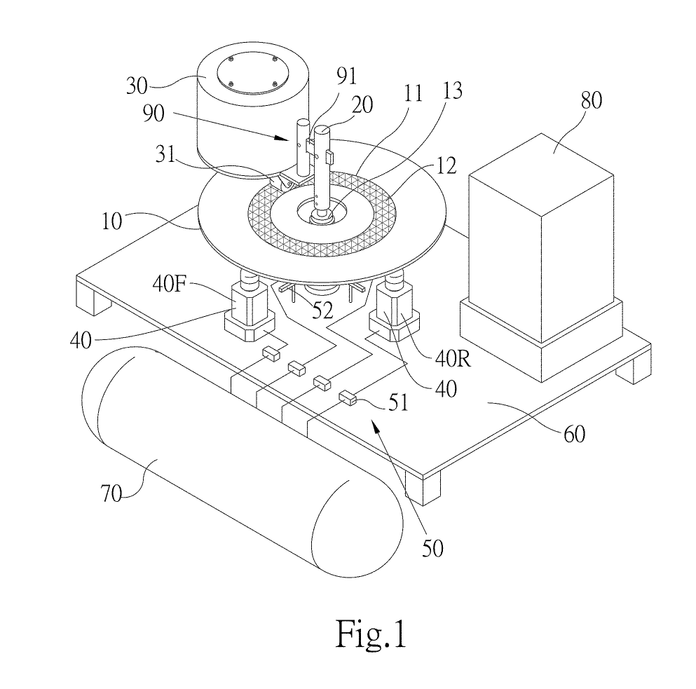

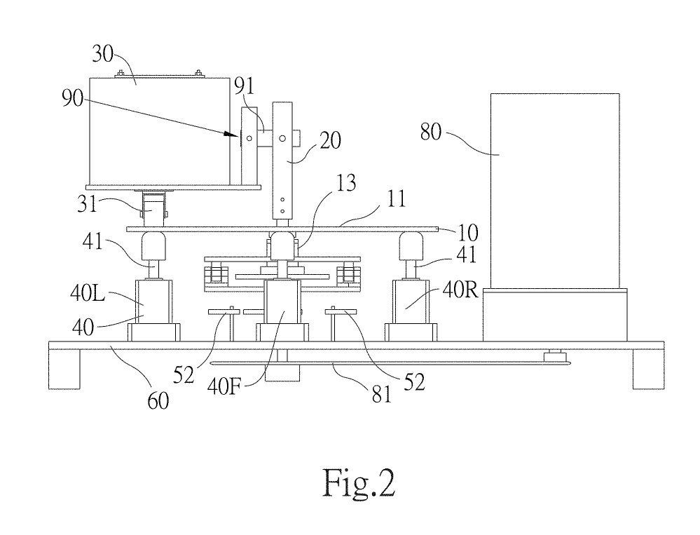

The present invention mainly provides a recirculating gradient power system. As shown in FIG. 1 and FIG. 2, the recirculating gradient power system of the present invention substantially comprises a motion carrier 10, a rotating shaft 20, a counterweight 30, a plurality of power cylinders 40, and a control module 50.

The motion carrier 10 is horizontally arranged and has a central vertical axis as a pivot to change its tilt orientation and tilt angle. In an embodiment, the motion carrier 10 may be a mechanical structure formed of a metal, a wood, plastics or a foam material by processing.

The rotating shaft 20 is vertically disposed at the position of the central vertical axis of the motion carrier 10.

The counterweight 30 is pivotally connected to the rotating shaft 20 through a coupling mechanism 90, and is rotationally displaced from the high point of the motion carrier 10 toward the lower point of the motion carrier 10 about the rotating shaft 20 by gravity to rotate the rotating shaft 20 synchronously. In an embodiment, the counterweight 30 is rotated through at least one roller 31 in contact with the motion carrier to roll on the motion carrier 10. In the present invention, the coupling mechanism 90 is used to connect the counterweight 30 and the rotating shaft 20. The coupling mechanism 90 may include an elbow member 91. Two ends of the elbow member 91 are pivotally connected to the rotating shaft 20 and the counterweight 30, respectively, i.e., the two ends of the elbow member 91 are respectively oscillated by the rotating shaft 20 and the counterweight 30, so that the roller 31 of the counterweight 30 can be kept in contact with the motion carrier 10 when the motion carrier 10 is tilted and oscillated.

As an example, the power cylinders 40 in the present invention can comprise at least four power cylinders. The at least four power cylinders 40 are evenly arranged at four diagonal corners around the periphery of the central vertical axis of the motion carrier 10. In this embodiment, the recirculating gradient power system of the present invention comprises four power cylinders 40 located at four diagonal corners in the horizontal transverse direction and in the horizontal longitudinal direction around the periphery of the central vertical axis of the motion carrier 10, i.e., four diagonal corners at the front side, the rear side, the left side and the right side as shown in the drawings. Each of the power cylinders 40 is provided with a push rod 41 connected with a pressure source to drive the motion carrier 10 to change its tilt orientation and tilt angle.

The control module 50 is connected with the power cylinders 40 for controlling the operation of the power cylinders 40 which are set in advance when the counterweight 30 is rotationally displaced to a predetermined stroke. In an embodiment, the control module 50 may be provided with a plurality of valve elements 51 connected with the power cylinders 40 and a plurality of contact sensing elements 52 corresponding to the rotating shaft 20, respectively, or a plurality of non-contact sensing elements (not shown) corresponding to the rotating shaft 20, respectively. The contact sensing elements 52 or the non-contact sensing elements (not shown) are adapted to sense the displacement of the rotating shaft 20 and the counterweight 30 to transmit control signals to the respective valve elements 51 which control the respective power cylinders 40. The control signals may be fluid signals such as electric current or airflow or liquid flow. Additionally, each of the valve elements 51 is connected with the pressure source, and thus two ends of each valve elements 51 are respectively connected with the pressure source and the corresponding power cylinder 40 via pipes (not labeled with number in the drawings). When the counterweight 30 is rotationally displaced to a predetermined stroke, the control module 50 controls the valve elements to be turned on/off to selectively make the power cylinders 40 be communicated with the pressure source, so as to control the operation of the power cylinders 40 which are set in advance.

In this embodiment, the recirculating gradient power system further comprises a base 60. The power cylinders 40 are fixed to the base 60. The rotating shaft 20 is pivotally disposed on the base 60. The motion carrier 10 is mounted on the base 60 through a universal coupling seat 13.

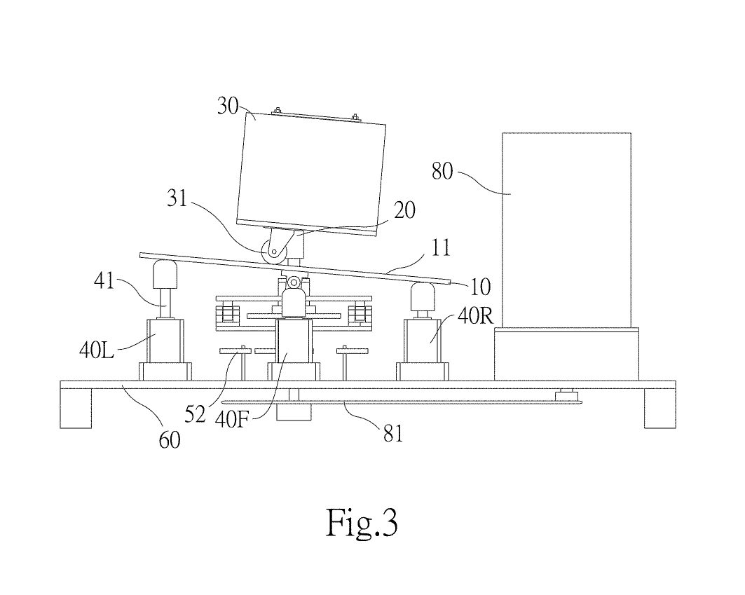

In principle, the recirculating gradient power system of the present invention allows the motion carrier 10 to continuously rotate in the direction of displacement of the counterweight 30 to change the tilt orientation by means of the compressed fluid supplied from a fluid accumulator unit 70 (i.e. the pressure source as mentioned above), such as a high pressure gas bottle, an air compressor or a hydraulic device connected with the power cylinders 40, under the operation of the control module 50 and all the power cylinders 40, as shown in FIG. 3 to FIG. 6. Normally, the counterweight 30 is rotationally displaced from the high point of the motion carrier 10 toward the lower point of the motion carrier 10 by gravity.

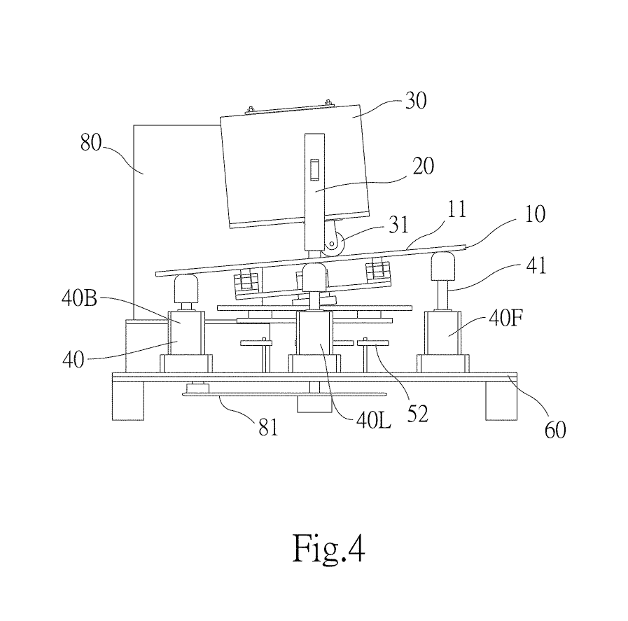

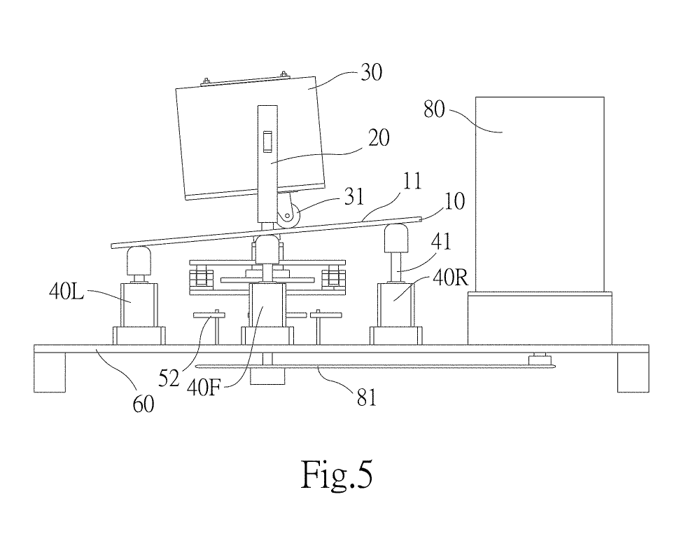

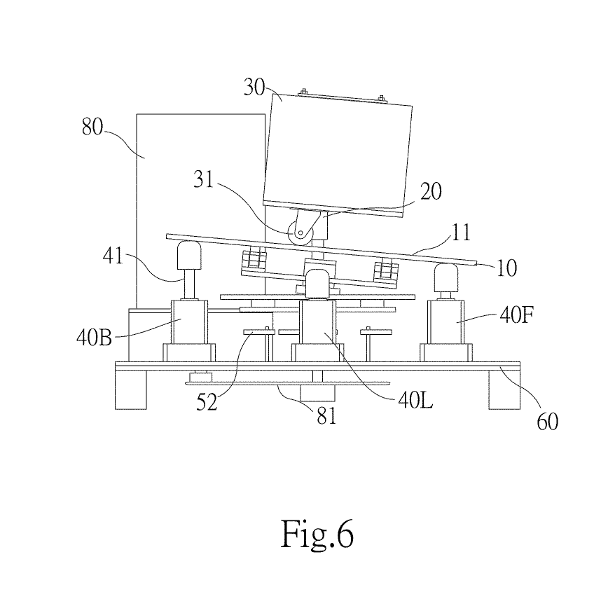

In practical operation, to conveniently describe the details, the four power cylinders 40 are sequentially labeled by the left-side power cylinder 40L, the front-side power cylinder 40F, the right-side power cylinder 40R and the back-side power cylinder 40B, along a counterclockwise direction. The fluid accumulator unit 70 can be the high pressure gas bottle, the air compressor or the hydraulic device for supplying the compressed fluid, and herein the fluid accumulator unit 70 is the air compressor, for example. When operating, whether the high pressure gas in all of the left-side power cylinder 40L, the front-side power cylinder 40F, the right-side power cylinder 40R and the back-side power cylinder 40B has been exhausted to the outside environment is checked, and then the following steps are executed. At Step (1), the power is turned to actuate the motor of the fluid accumulator unit 70 (i.e. air compressor) to generate the high pressure air, wherein during the operation of the recirculating gradient power system, the electrical power is continuously provided to the air compressor to keep the motor operates continuously, so as to make sure that amount of the high pressure air which is larger than a threshold is continuously provided to the corresponding power cylinder 40 during the operation of the recirculating gradient power system. At Step (2), the counterweight 30 is moved to the position corresponding to the left-side power cylinder 40L. At Step (3), the control module 50 controls the valve element 51 corresponding to the left-side power cylinder 40L to be turned on, thus the air compressor provides the high pressure air to the left-side power cylinder 40L, and at the same time, the control module 50 controls the valve element 51 corresponding to the right-side power cylinder 40R to be turned off, resulting that the push rod 41 of the left-side power cylinder 40L is pulled up. Therefore, the motion carrier 10 changes its tilt orientation and tilt angle around its central vertical axis (i.e. the pivot axis is its central vertical axis), and the left side of the motion carrier 10 becomes the high point and the right side of the motion carrier 10 becomes the low point, so as to form a starting gradient. The counterweight 30 having the gravity potential energy due to the gravity can rotate counterclockwise from the high point of the motion carrier 10 to the low point of the motion carrier 10, to convert the gravity potential energy into kinetic energy, and the rotating shaft 20 is driven to rotate counterclockwise. At Step (4), when the contact sensing elements 52 detects that the counterweight 30 reaches the position corresponding to the front-side cylinder 40F, the control module 50 controls the valve element 51 corresponding to the back-side power cylinder 40B to be turned off, next, the high pressure gas in the back-side power cylinder 40B is exhausted to the outside environment to decline the push rod 41 of the back-side power cylinder 40B, the push rod 41 of the left-side power cylinder 40L maintains the ascending status, and the control module 50 controls the valve element 51 corresponding to the front-side power cylinder 40F to be turned on to make the air compressor provide the high pressure gas to the front-side power cylinder 40F, thus resulting that the push rod 41 of the front-side power cylinder 40F is pulled up. Therefore, the motion carrier 10 changes its tilt orientation and tilt angle around its central vertical axis (i.e. the pivot axis is its central vertical axis) again, and the left side and the front side of the motion carrier 10 becomes the high point and the right side and the back side of the motion carrier 10 becomes the low point, so as to form a first gradient. The counterweight 30 having the gravity potential energy due to the gravity can continuously rotate counterclockwise from the high point of the motion carrier 10 to the low point of the motion carrier 10, and the rotating shaft 20 is driven to rotate counterclockwise, as shown in FIG. 4. At Step (5), when the contact sensing elements 52 detects that the counterweight 30 reaches the position corresponding to the right-side cylinder 40R, the control module 50 controls the valve element 51 corresponding to the left-side power cylinder 40L to be turned off, next, the high pressure gas in the left-side power cylinder 40L is exhausted to the outside environment to decline the push rod 41 of the left-side power cylinder 40L, the push rod 41 of the front-side power cylinder 40F maintains the ascending status, and the control module 50 controls the valve element 51 corresponding to the right-side power cylinder 40R to be turned on to make the air compressor provide the high pressure gas to the right-side power cylinder 40R, thus resulting that the push rod 41 of the right-side power cylinder 40R is pulled up. Therefore, the motion carrier 10 changes its tilt orientation and tilt angle around its central vertical axis (i.e. the pivot axis is its central vertical axis) again, and the front side and the right side of the motion carrier 10 become the high point and the back side and the left side of the motion carrier 10 become the low point, so as to form a second gradient. The counterweight 30 having the gravity potential energy due to the gravity can continuously rotate counterclockwise from the high point of the motion carrier 10 to the low point of the motion carrier 10, and the rotating shaft 20 is driven to rotate counterclockwise, as shown in FIG. 5. At Step (6), when the contact sensing elements 52 detects that the counterweight 30 reaches the position corresponding to the back-side power cylinder 40B, the control module 50 controls the valve element 51 corresponding to the front-side power cylinder 40F to be turned off, next, the high pressure gas in the front-side power cylinder 40F is exhausted to the outside environment to decline the push rod 41 of the front-side power cylinder 40F, the push rod 41 of the right-side power cylinder 40R maintains the ascending status, and the control module 50 controls the valve element 51 corresponding to the back-side power cylinder 40B to be turned on to make the air compressor provide the high pressure gas to the back-side power cylinder 40B, thus resulting that the push rod 41 of the back-side power cylinder 40B is pulled up. Therefore, the motion carrier 10 changes its tilt orientation and tilt angle around its central vertical axis (i.e. the pivot axis is its central vertical axis) again, and the back side and the right side of the motion carrier 10 become the high point and the front side and the left side of the motion carrier 10 become the low point, so as to form a third gradient. The counterweight 30 having the gravity potential energy due to the gravity can continuously rotate counterclockwise from the high point of the motion carrier 10 to the low point of the motion carrier 10, and the rotating shaft 20 is driven to rotate counterclockwise, as shown in FIG. 6. At Step (7), when the contact sensing elements 52 detects that the counterweight 30 reaches the position corresponding to the left-side cylinder 40L, the control module 50 controls the valve element 51 corresponding to the right-side power cylinder 40R to be turned off, next, the high pressure gas in the right-side power cylinder 40R is exhausted to the outside environment to decline the push rod 41 of the right-side power cylinder 40R, the push rod 41 of the back-side power cylinder 40B maintains the ascending status, and the control module 50 controls the valve element 51 corresponding to the left-side power cylinder 40L to be turned on to make the air compressor provide the high pressure gas to the left-side power cylinder 40L, thus resulting that the push rod 41 of the left-side power cylinder 40L is pulled up. Therefore, the motion carrier 10 changes its tilt orientation and tilt angle around its central vertical axis (i.e. the pivot axis is its central vertical axis) again, and the back side and the left side of the motion carrier 10 become the high point and the front side and the right side of the motion carrier 10 become the low point, so as to form a fourth gradient. The counterweight 30 having the gravity potential energy due to the gravity can continuously rotate counterclockwise from the high point of the motion carrier 10 to the low point of the motion carrier 10, and the rotating shaft 20 is driven to rotate counterclockwise, as shown in FIG. 3.

Next, Step (4) is executed again, and the Steps (4)-(7) are repeatedly executed to form the proceeding process of the recirculating gradient power system, and the first through fourth gradients are repeatedly formed, such that a continuous virtual gradient is formed, and the counterweight 30 can continuously obtain the gravity potential energy on the continuous virtual gradient and continuously convert the gravity potential energy to the kinetic energy to make the rotating shaft 20 continuously rotate counterclockwise. In the practical application, the recirculating gradient power system can be the teaching tool or the playing facility of the playground which requires the continuous rotation, and the rotating shaft 20 is utilized to drive a generator 80 to operate, such that the generator 80 can generate the electrical power and recycle the portion of the electrical power which is supplied to the air compressor.

As shown in FIG. 1 and FIG. 2, the recirculating gradient power system of the present invention, when implemented, may further comprise at least one generator 80 to constitute a transmission coupling in cooperation with the rotating shaft 20. The at least one generator 80 is connected with the rotating shaft 20 through a variable speed unit 81.

Further, the recirculating gradient power system of the present invention may further comprise at least one fluid accumulator unit 70 connected to each of the power cylinders 40. The at least one fluid accumulator unit 70 is an air compressor or a hydraulic device. Preferably, the recirculating gradient power system may further comprise at least one generator 80 to constitute a transmission coupling in cooperation with the rotating shaft 20 and at least one fluid accumulator unit 70 connected to each of the power cylinders 40.

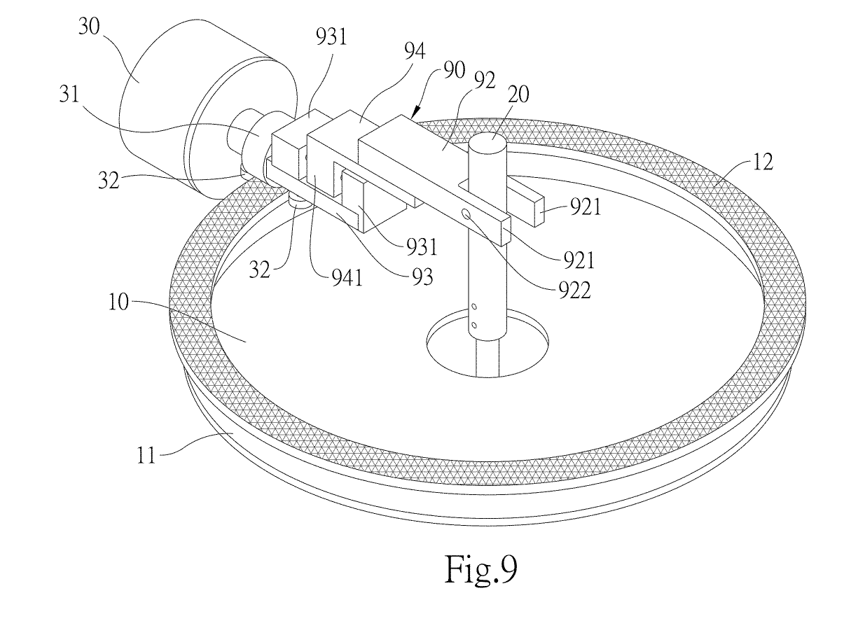

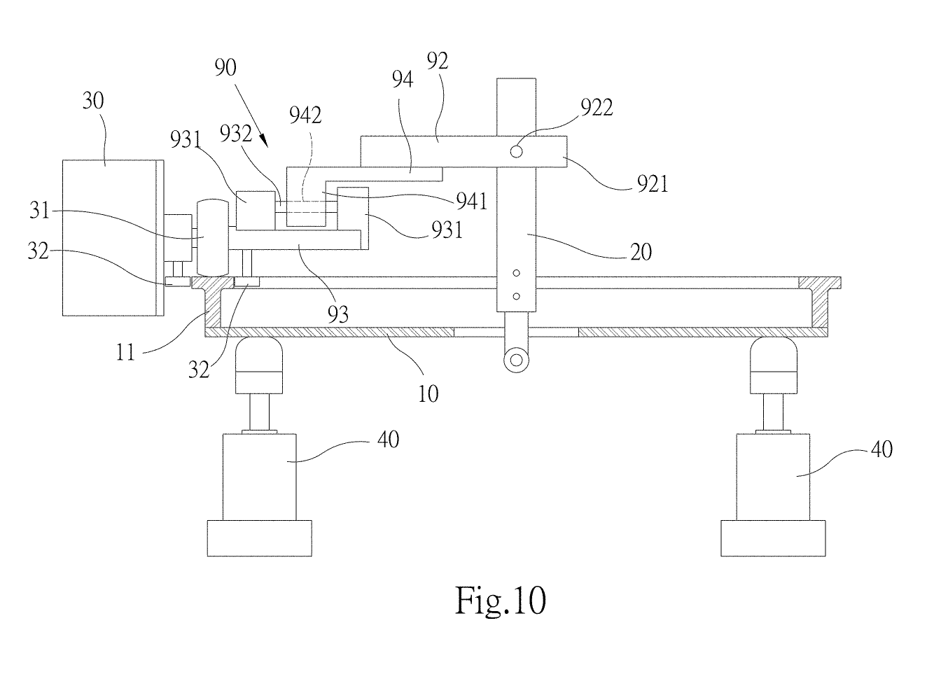

It is noted that the counterweight 30 of the recirculating gradient power system of the present invention is provided with at least one roller 31 in contact with the motion carrier 10 to maintain the smooth running and reduce the friction loss. Furthermore, as shown in FIG. 9 and FIG. 10, the motion carrier 10 may be provided with an annular track 11, and the counterweight 30 is provided with at least one roller 31 to roll on the track 11. The motion carrier 10 and the track 11 may be manufactured with different materials to reduce the material cost. Only the track 11 is replaced when the track 11 suffers a lot of wear and tear or is damaged. It is noted that, a cross section of the track 11 is a T-shaped structure, wherein the roller 31 contacts a top portion of the T-shaped structure, and a bottom portion of the T-shaped structure is connected with the motion carrier 10. The design of the T-shaped structure can efficiently maintain the strength of the track, and further reduce the weight of the track 11. The bottom portion of the T-shaped structure can be connected with the motion carrier 10 by screwing or engaging, such that it is easy to replace the track 11.

Under the structure that the motion carrier 10 is provided with an annular track 11 and the counterweight 30 is provided with at least one roller 31 to roll on the track 11. The counterweight 30 may be provided with at least two auxiliary rollers 32 respectively corresponding to two sides of the track 11 to ensure that the roller 31 is surely rolled on the track 11.

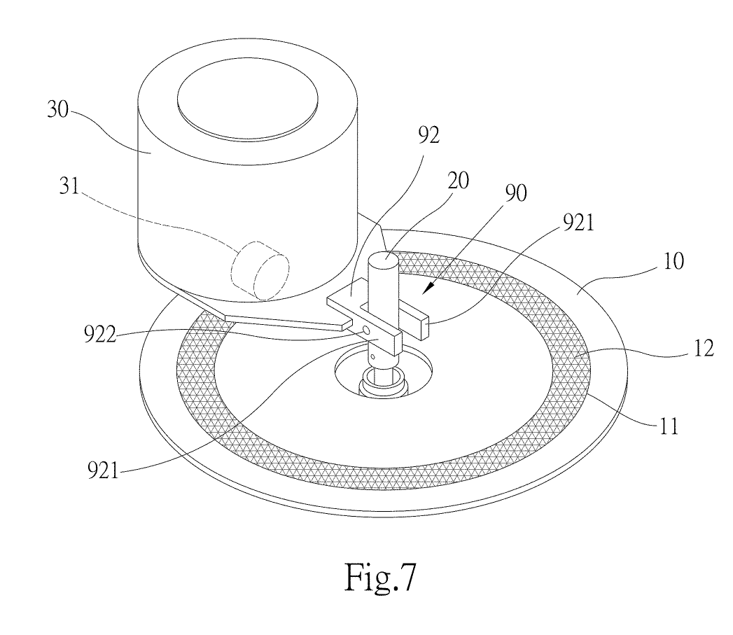

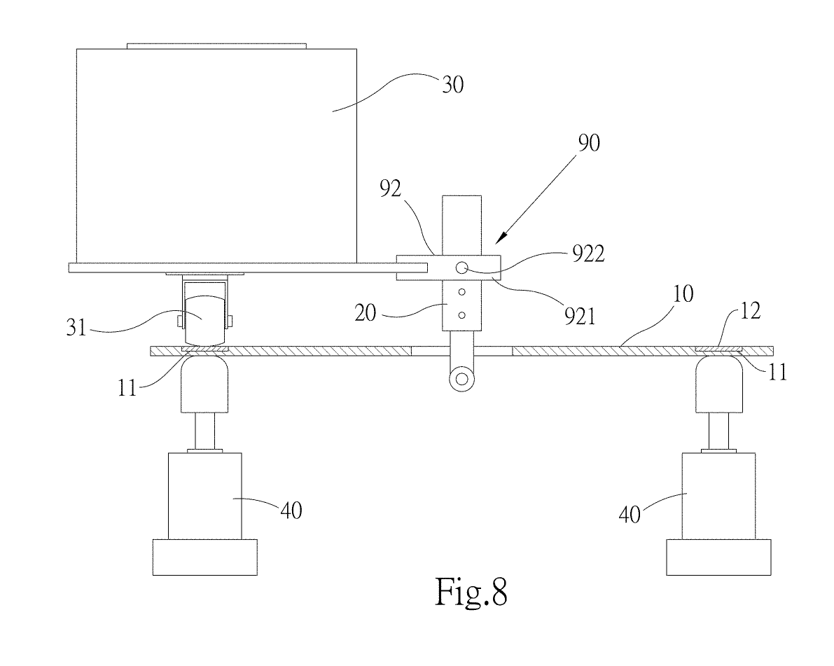

In addition, the coupling mechanism 90, as shown in FIG. 7 and FIG. 8, may be provided with a pivot member 92 fixed to the counterweight 30. One end of the pivot member 92 is formed with two arms 921 corresponding to two sides of the rotating shaft 20. A pin 922 is provided to penetrate the two arms 921 and the rotating shaft 20 so as to connect the counterweight 30 and the rotating shaft 20. This provides a pivot effect for the roller 31 of the counterweight 30 to get contact with the motion carrier 10 when the motion carrier 10 is tilted and oscillated.

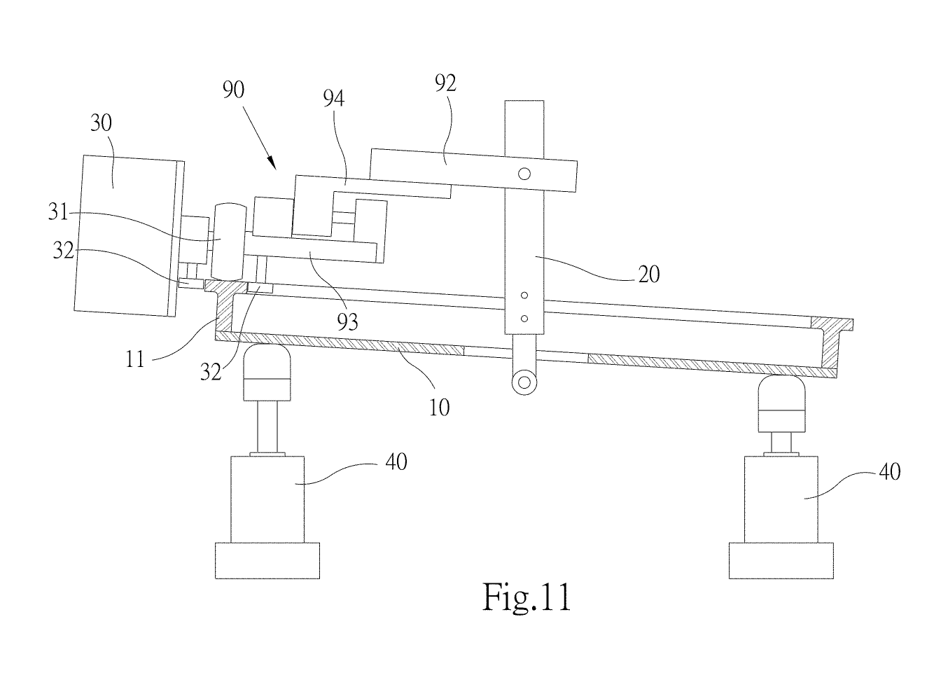

Furthermore, the coupling mechanism 90, as shown in FIG. 9 and FIG. 10, is provided with a first connecting member 93 fixed to the counterweight 30. A second connecting member 94 is mounted on the first connecting member 93 and is telescopic relative to the first connecting member 93. One end of the second connecting member 94 is provided with a pivot member 92. One end of the pivot member 92 is formed with two arms 921 corresponding to two sides of the rotating shaft 20. A pin 922 is provided to penetrate the two arms 921 and the rotating shaft 20. This provides a pivot effect for the roller 31 of the counterweight 30 to get contact with the motion carrier 10 when the motion carrier 10 is tilted and oscillated. Furthermore, the second connecting member 94 is telescopic relative to the first connecting member 93 (as shown in FIG. 10 and FIG. 11) to prevent the roller 31 of the counterweight 30 from slipping, thereby greatly reducing the wear and the friction loss of the roller 31.

According to the aforesaid embodiments of the recirculating gradient power system of the present invention, the recirculating gradient power system can be presented as the following implementations:

In the embodiment shown in FIG. 1 and FIG. 2, the counterweight 30 is disposed at a position where the center of mass of the counterweight 30 is located above the motion carrier 10. The counterweight 30 is provided with four rollers 31 in contact with the motion carrier 10 to roll on the motion carrier 10. The coupling mechanism 90 is provided with an elbow member 91. Two ends of the elbow member 91 are pivotally connected to the rotating shaft 20 and the counterweight 30, respectively.

In the embodiment shown in FIG. 7 and FIG. 8, the counterweight 30 is disposed at a position where the center of mass of the counterweight 30 is located above the motion carrier 10. The counterweight 30 is provided with a roller 31 in contact with the motion carrier 10 to roll on the motion carrier 10. The roller 31 has an arc surface. The coupling mechanism 90 is provided with a pivot member 92 fixed to the counterweight 30. One end of the pivot member 92 is formed with two arms 921 corresponding to two sides of the rotating shaft 20. A pin 922 is provided to penetrate the two arms 921 and the rotating shaft 20.

In the embodiment shown in FIG. 9 through FIG. 11, the counterweight 30 is disposed at a position where the center of mass of the counterweight 30 is located at an outer side of the motion carrier 10. The motion carrier 10 is provided with an annular track 11. The counterweight 30 is provided with a roller 31 to roll on the track 11. The counterweight 30 is provided with at least two auxiliary rollers 32 respectively corresponding to two sides of the track 11. The roller 31 has an arc surface. The coupling mechanism 90 is provided with a first connecting member 93 fixed to the counterweight 30. A second connecting member 94 is mounted on the first connecting member 93 and is telescopic relative to the first connecting member 93. One end of the second connecting member 94 is provided with a pivot member 92. One end of the pivot member 92 is formed with two arms 921 corresponding to two sides of the rotating shaft 20. A pin 922 is provided to penetrate the two arms 921 and the rotating shaft 20. The first connecting member 93 is provided with two first stoppers 931 thereon. At least one guide post 932 is provided between the two first stoppers 931. The second connecting member 94 is provided with a first sliding seat 941 inserted between the two first stoppers 931. The first sliding seat 941 is provided with at least one guide hole 942 for the guide post 932 of the first connecting member 93 to insert therethrough. It is noted that, the counterweight 30 is disposed at a position where the center of mass of the counterweight 30 is located at an outer side of the annular track 11.

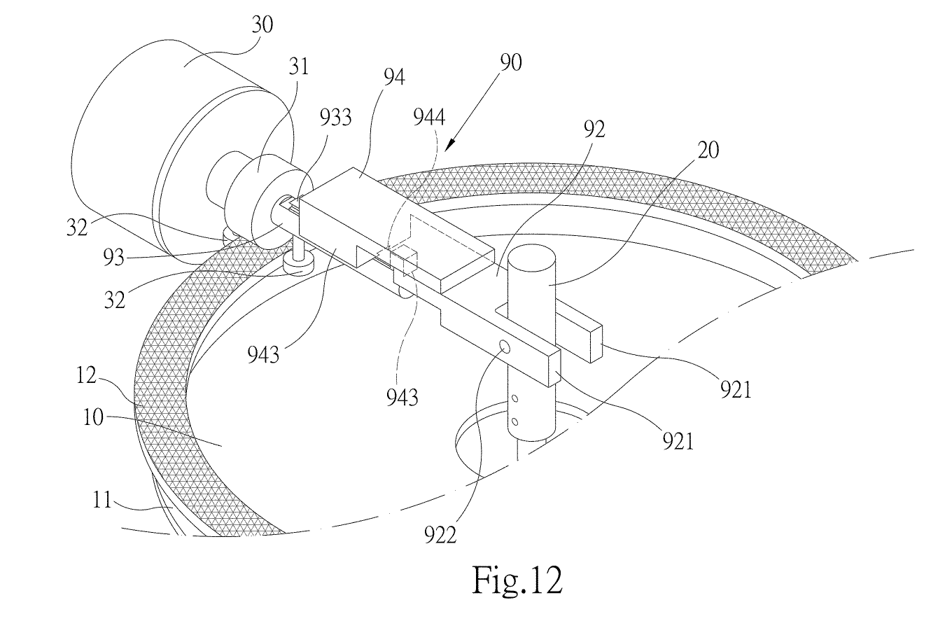

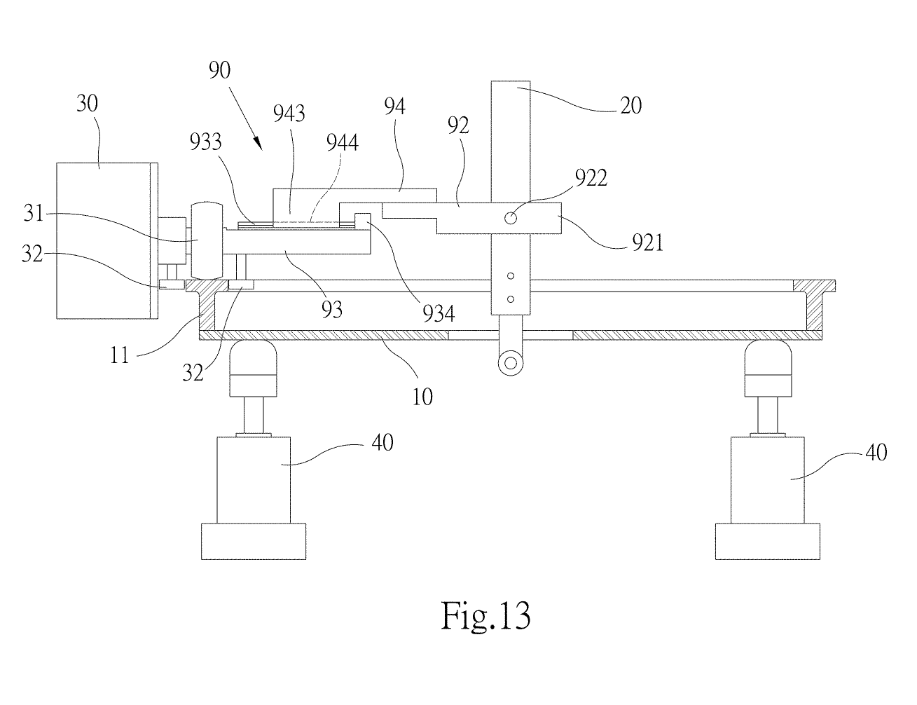

In the embodiment shown in FIG. 12 and FIG. 13, the counterweight 30 is disposed at a position where the center of mass of the counterweight 30 is located at an outer side of the motion carrier 10. The motion carrier 10 is provided with an annular track 11. The counterweight 30 is provided with a roller 31 for rolling on the track 11. The counterweight 30 is provided with at least two auxiliary rollers 32 respectively corresponding to two sides of the track 11. The roller 31 has an arc surface. The coupling mechanism 90 is provided with a first connecting member 93 fixed to the counterweight 30. A second connecting member 94 is mounted on the first connecting member 93 and is telescopic relative to the first connecting member 93. One end of the second connecting member 94 is provided with a pivot member 92. One end of the pivot member 92 is formed with two arms 921 corresponding to two sides of the rotating shaft 20. A pin 922 is provided to penetrate the two arms 921 and the rotating shaft 20. The first connecting member 93 is provided with a slide rail 933 thereon. A tail end of the first connecting member 93 is provided with a second stopper 934. The second connecting member 94 is provided with a second sliding seat 943. The second sliding seat 943 is provided with at least one chute 944 corresponding to the slide rail 933 of the first connecting member 93. It is noted that, the counterweight 30 is disposed at a position where the center of mass of the counterweight 30 is located at an outer side of the annular track 11.

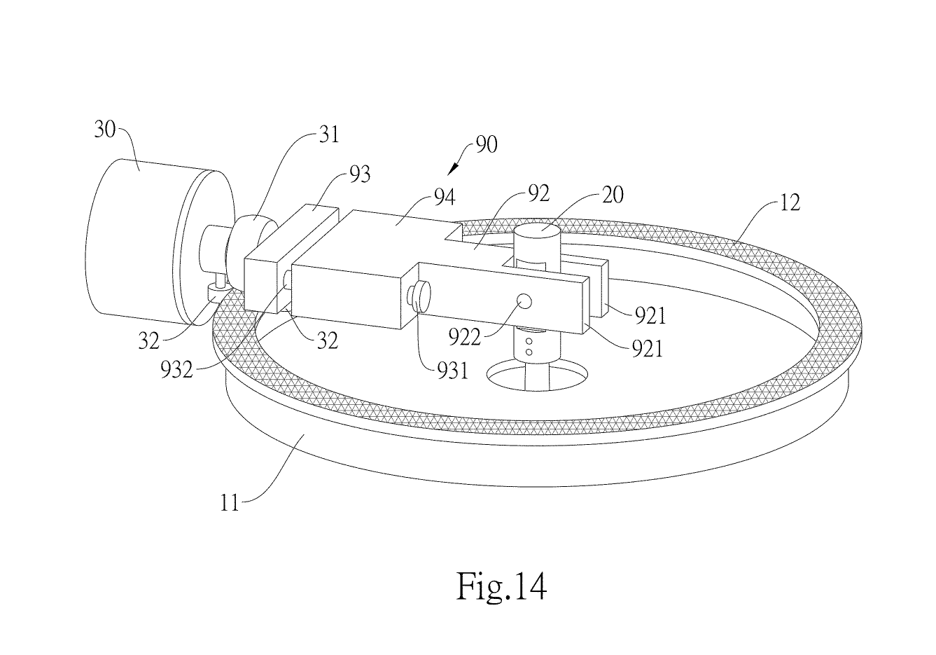

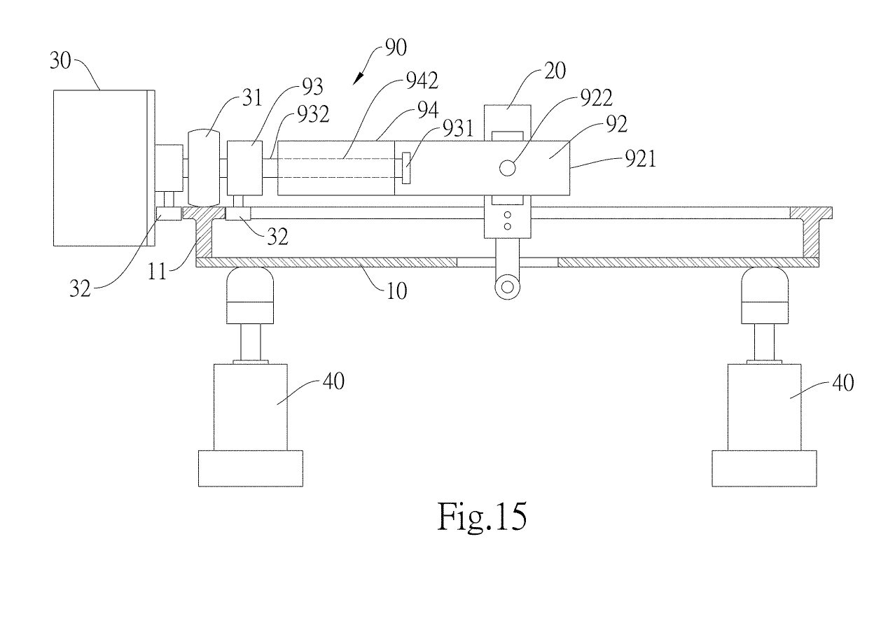

In the embodiment of FIG. 14 and FIG. 15, the counterweight 30 is disposed at a position where the center of mass of the counterweight 30 is located at an outer side of the motion carrier 10. The motion carrier 10 is provided with a track 11 being annularly disposed on the motion carrier 10. The counterweight 30 is provided with at least two auxiliary rollers 32 respectively corresponding to two sides of the track 11, the roller 11 has the arc surface. The coupling mechanism 90 is provided with a first connecting member 93 fixed to the counterweight 30. The second connecting member 94 is mounted on the first connecting member 93 and is telescopic relative to the first connecting member 93. One end of the second connecting member 94 is provided with a pivot member 92, one end of the pivot member 92 is formed with two arms 921 corresponding to two sides of the rotating shaft 20, and a pin 922 is provided to penetrate the two arms 921 and the rotating shaft 20. The first connecting member 93 is provided with at least one guide post 932, and the terminal end of the guide post 932 has the first stopper 931. The second connecting member 94 is provided with at least one guide hole 942 for the guide post 932 of the first connecting member 93 to insert therethrough. It is noted that, the counterweight 30 is disposed at a position where the center of mass of the counterweight 30 is located at an outer side of the track 11.

In the different embodiments shown in FIG. 7 to FIG. 13, the surface of the roller 31 is designed in an arc shape as a connecting line from the counterweight 30 to the pivot point of the rotating shaft 20 when the motion carrier 10 is tilted and oscillated. When the included angle between the counterweight 30 and the axis of the motion carrier 10 is changed, the contact point between the roller 31 and the motion carrier 10 is smoothly changed from the inner side of the roller 31 to the outer side of the roller 31 or from the outer side of the roller 31 to the inner side of the roller 31 so as to prevent the counterweight 30 from vibrating or jumping, thereby maintaining the smoothness and stability of the operation.

In the respective embodiments shown in FIG. 9 to FIG. 13, the center of mass of the counterweight 30 is located at an outer side of the motion carrier 10, and even the center of mass of the counterweight 30 is kept at the connecting line from the counterweight 30 to the pivot point of the rotating shat 20 so as to prevent the counterweight 30 from being tilted forward or rearward.

It is noted that, during the operation of the circulating gradient power system, taking the embodiment which the annular tracks have the same diameter as an example, compared to the case that the counterweight 30 is disposed at a position where the center of mass of the counterweight 30 is located on the motion carrier 10, the case that the counterweight 30 is disposed at a position where the center of mass of the counterweight 30 is located at an outer side of the motion carrier 10 can have the larger gravity potential energy at Steps (3)-(7), and the converted kinetic energy is also larger.

In the circulating gradient power system of the present invention, the roller 31 of the counterweight 30 of the embodiments shown in FIG. 1 to FIG. 6 or FIG. 7 and FIG. 8 is in contact with the motion carrier 10. The motion carrier 10, as shown in FIG. 7 and FIG. 8, may be provided with a wear-resistant structure 12 corresponding to the rolling route of the roller 31 to reduce friction loss, and for example, the wear-resistant structure 12 is disposed on the surface of the track 11 which contacts the roller 31. For another example, the top portion of the T-shaped structure can have the wear-resistant structure 12, as shown in FIG. 9, FIG. 12 and FIG. 14. In an embodiment, the wear-resistant structure 12 may be formed of a wear-resistant material coated on the surface of the track 11, or the surface of the track 11 is treated with a polishing process, such that the service life of the track 11 can be improved in addition to the reduction of the running noise.

Compared with the prior art, the circulating gradient power system of the prevent invention has a track 11 annularly disposed on the motion carrier 10, the surface of the track 11 has the wear-resistant structure 12, and thus when the track 11 has been worn or damaged, merely the track 11 should be replaced without replacing the whole motion carrier 10. Further, the cross section of the track 11 is the T-shaped structure, and the design of the T-shaped structure can efficiently maintain the strength of the track 11, and further reduce the weight of the track 11. Moreover, the counterweight 30 is disposed at a position where the center of mass of the counterweight 30 is located at an outer side of the motion carrier 10, thus the counterweight 30 can have the larger gravity potential energy at, and the converted kinetic energy is also larger.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A recirculating gradient power system, comprising:
a motion carrier, horizontally arranged, having a central vertical axis as a pivot to change its tilt orientation and tilt angle, the motion carrier being provided with a track being annularly disposed on the motion carrier;
a rotating shaft, vertically disposed at the position of the central vertical axis of the motion carrier;
a counterweight, pivotally connected to the rotating shaft through a coupling mechanism, the counterweight being rotationally displaced from a high point of the motion carrier toward a lower point of the motion carrier about the rotating shaft by gravity to rotate the rotating shaft synchronously, the counterweight being provided with at least one roller in contact with the track to roll on the track, two ends of the coupling mechanism being pivotally connected to the rotating shaft and the counterweight respectively, and the counterweight being disposed at a position where the center of mass of the counterweight is located at an outer side of the motion carrier;
a plurality of power cylinders, evenly arranged at diagonal corners around the periphery of the central vertical axis of the motion carrier, each of the power cylinders being provided with a push rod connected with a pressure source to drive the motion carrier to change the tilt orientation and the tilt angle, the pressure source being a fluid accumulator unit;
a control module, being provided with a plurality of valve elements connected with the power cylinders, and two ends of each the valve elements being respectively connected with the pressure source and the corresponding power cylinder via pipes, respectively, wherein when the counterweight is rotationally displaced to a predetermined stroke, the control module controls the valve elements to be turned on/off to selectively make the power cylinders be communicated with the pressure source, so as to control the operation of the power cylinders which are set in advance;
wherein a surface of the track which contacts the roller is provided with a wear-resistant structure, and the wear-resistant structure is formed of a wear-resistant material, or formed by polishing the surface of the track.

2. The recirculating gradient power system as claimed in claim 1, wherein the counterweight is disposed at a position where the center of mass of the counterweight is located at an outer side of the track.

3. The recirculating gradient power system as claimed in claim 2, wherein a cross section of the track is a T-shaped structure, wherein the roller contacts a top portion of the T-shaped structure, and a bottom portion of the T-shaped structure is connected with the motion carrier.

4. The recirculating gradient power system as claimed in claim 3, wherein the counterweight is provided with at least two auxiliary rollers respectively corresponding to two sides of the track

5. The recirculating gradient power system as claimed in claim 4, wherein the coupling mechanism is provided with a pivot member fixed to the counterweight, one end of the pivot member is formed with two arms corresponding to two sides of the rotating shaft, and a pin is provided to penetrate the two arms and the rotating shaft.

6. The recirculating gradient power system as claimed in claim 4, wherein the coupling mechanism is provided with a first connecting member fixed to the counterweight, a second connecting member is mounted on the first connecting member and is telescopic relative to the first connecting member, one end of the second connecting member is provided with a pivot member, one end of the pivot member is formed with two arms corresponding to two sides of the rotating shaft, and a pin is provided to penetrate the two arms and the rotating shaft.

7. The recirculating gradient power system as claimed in claim 6, wherein the roller has an arc surface; the first connecting member is provided with two first stoppers thereon, at least one guide post is provided between the two first stoppers; the second connecting member is provided with a first sliding seat inserted between the two first stoppers, and the first sliding seat is provided with at least one guide hole for the guide post of the first connecting member to insert therethrough.

8. The recirculating gradient power system as claimed in claim 6, wherein the roller has an arc surface; the first connecting member is provided with a slide rail thereon, a tail end of the first connecting member is provided with a second stopper; the second connecting member is provided with a second sliding seat, and the second sliding seat is provided with at least one chute corresponding to the slide rail of the first connecting member.

9. The recirculating gradient power system as claimed in claim 6, wherein the roller has an arc surface; the first connecting member is provided with a guide post; the second connecting member is provided with a guide hole for the guide post of the first connecting member to insert therethrough.

10. The recirculating gradient power system as claimed in claim 1, further comprising a base, the power cylinders being fixed to the base, the rotating shaft being pivotally disposed on the base, the motion carrier being mounted on the base through a universal coupling seat.

11. The recirculating gradient power system as claimed in claim 1, further comprising at least one generator to constitute a transmission coupling in cooperation with the rotating shaft.

12. The recirculating gradient power system as claimed in claim 1, wherein the control module is provided with a plurality of contact sensing elements corresponding to the rotating shaft, respectively, or a plurality of non-contact sensing elements corresponding to the rotating shaft, respectively.
